(19) United States
(12) Patent Application Publication
(10) Pub. No.: US 2026/0323709 A1
(43) Pub. Date: Oct. 15, 2026

(54) USER EQUIPMENT ASSISTED RANDOM ACCESS

(71) Applicant: QUALCOMM Incorporated, San Diego, CA (US)

(72) Inventors: Tommy AZZINO, Jersey City, NJ (US); Navid ABEDINI, Basking Ridge, NJ (US); Jianghong LUO, Skillman, NJ (US)

(21) Appl. No.: 19/176,736

(22) Filed: Apr. 11, 2025

(51) Int. Cl. H04W 74/0833; H04B 7/06; H04W 72/1268; H04W 72/21

(52) U.S. Cl. CPC H04W 74/0833; H04B 7/0626; H04W 72/1268; H04W 72/21

(57) ABSTRACT

Various aspects of the present disclosure generally relate to wireless communication. In some aspects, an assisting user equipment (UE) may receive, from an assisted UE, a first message indicating that the assisted UE is to establish a connection between the assisted UE and a network node. The UE may transmit, to the network node, a second message associated with a random access channel process for establishing a connection between the assisted UE and the network node. Numerous other aspects are described.

### FIELD OF THE DISCLOSURE

Aspects of the present disclosure generally relate to wireless communication and specifically relate to techniques, apparatuses, and methods associated with user equipment assisted random access.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a four-step random access procedure.

FIG. 3 is a diagram illustrating an example of user equipment (UE) assisted random access.

FIG. 4 is a diagram illustrating an example process performed, for example, at a UE or an apparatus of a UE.

FIG. 5 is a diagram illustrating an example process performed, for example, at a UE or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### SUMMARY

In some aspects, a method of wireless communication performed by an assisting user equipment (UE) includes receiving, from an assisted UE, a first message indicating that the assisted UE is to establish a connection between the assisted UE and a network node; and transmitting, to the network node, a second message associated with a random access channel process for establishing a connection between the assisted UE and the network node.

In some aspects, a method of wireless communication performed by an assisted UE includes transmitting, to an assisting UE, a message indicating that the assisted UE is to establishing a connection between the assisted UE and a network node; and receiving, from at least one of the assisting UE or the network node, information associated with a random access channel process for establishing the connection between the assisted UE and the network node.

In some aspects, a method of wireless communication performed by a network node includes receiving, from an assisting UE, a message indicating that an assisted UE is to establishing a connection between the assisted UE and the network node; and transmitting, to at least one of the assisting UE or the assisted UE, information associated with a random access channel process for establishing a connection between the assisted UE and the network node.

In some aspects, an apparatus for wireless communication at an assisting UE includes one or more memories; and one or more processors, coupled to the one or more memories, configured to cause the UE to: receive, from an assisted UE, a first message indicating that the assisted UE is to establish a connection between the assisted UE and a network node; and transmit, to the network node, a second message associated with a random access channel process for establishing a connection between the assisted UE and the network node.

In some aspects, an apparatus for wireless communication at an assisted UE includes one or more memories; and one or more processors, coupled to the one or more memories, configured to cause the UE to: transmit, to an assisting UE, a message indicating that the assisted UE is to establishing a connection between the assisted UE and a network node; and receive, from at least one of the assisting UE or the network node, information associated with a random access channel process for establishing the connection between the assisted UE and the network node.

In some aspects, an apparatus for wireless communication at a network node includes one or more memories; and one or more processors, coupled to the one or more memories, configured to cause the network node to: receive, from an assisting UE, a message indicating that an assisted UE is to establishing a connection between the assisted UE and the network node; and transmit, to at least one of the assisting UE or the assisted UE, information associated with a random access channel process for establishing a connection between the assisted UE and the network node.

In some aspects, a non-transitory computer-readable medium storing a set of instructions for wireless communication includes one or more instructions that, when executed by one or more processors of an assisting UE, cause the UE to: receive, from an assisted UE, a first message indicating that the assisted UE is to establish a connection between the assisted UE and a network node; and transmit, to the network node, a second message associated with a random access channel process for establishing a connection between the assisted UE and the network node.

In some aspects, a non-transitory computer-readable medium storing a set of instructions for wireless communication includes one or more instructions that, when executed by one or more processors of an assisted UE, cause the UE to: transmit, to an assisting UE, a message indicating that the assisted UE is to establishing a connection between the assisted UE and a network node; and receive, from at least one of the assisting UE or the network node, information associated with a random access channel process for establishing the connection between the assisted UE and the network node.

In some aspects, a non-transitory computer-readable medium storing a set of instructions for wireless communication includes one or more instructions that, when executed by one or more processors of a network node, cause the network node to: receive, from an assisting UE, a message indicating that an assisted UE is to establishing a connection between the assisted UE and the network node; and transmit, to at least one of the assisting UE or the assisted UE, information associated with a random access channel process for establishing a connection between the assisted UE and the network node.

In some aspects, an apparatus for wireless communication includes means for receiving, from an assisted UE, a first message indicating that the assisted UE is to establish a connection between the assisted UE and a network node; and means for transmitting, to the network node, a second message associated with a random access channel process for establishing a connection between the assisted UE and the network node.

In some aspects, an apparatus for wireless communication includes means for transmitting, to an assisting UE, a message indicating that the assisted UE is to establishing a connection between the assisted UE and a network node; and means for receiving, from at least one of the assisting UE or the network node, information associated with a random access channel process for establishing the connection between the assisted UE and the network node.

In some aspects, an apparatus for wireless communication includes means for receiving, from an assisting UE, a message indicating that an assisted UE is to establishing a connection between the assisted UE and a network node; and means for transmitting, to at least one of the assisting UE or the assisted UE, information associated with a random access channel process for establishing a connection between the assisted UE and the network node.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### DETAILED DESCRIPTION

Random access is a process in wireless communications that allows a user equipment (UE) or other device to initiate communication with a network node. Random access may serve as the entry point for the UE to establish an initial connection to the network node or to reconnect to the network node after being inactive for a time period. An example random access channel (RACH) process may include the UE transmitting a random access preamble to the network node on a physical random access channel (PRACH), the network node responding to the UE with a random access response (RAR), the UE transmitting connection request information to the network node, and the network node providing contention resolution information to the UE in accordance with multiple UEs selecting the same preamble.

UE collaboration (which may also be referred to herein as UE cooperation) refers to a process of multiple UEs that are collocated or moving together working collectively to optimize network operations. In this framework, one or more UEs within a group can be elected as “assisting UEs” to help other. “Assisted UEs” perform various tasks, such as by relaying communications, sharing channel state information, or handling authentication processes. When collocated UEs are not able to assist each other, several problems may emerge in the wireless communication network. For example, access latency may increase as each UE may need to independently complete the entire RACH process with the network node, resulting in longer connection establishment times. Additionally, contention resolution may become less efficient since multiple UEs from the same area may simultaneously attempt to access the network, thereby increasing the burden on the network node to distinguish and process the requests from these UEs individually. Further, energy consumption may increase as each UE may need to expend power for transmission and reception during the random access process (rather than sharing these energy-intensive tasks). Even further, the likelihood of collision may increase when multiple nearby UEs attempt to select random access preambles independently, potentially selecting the same preamble and causing transmission conflicts that require retransmissions.

Various aspect generally relate to wireless communications. Some aspects more specifically relate to UE-assisted random access. An assisted UE may obtain system information (SI) or a synchronization signal block (SSB) associated with a network node (e.g., a target cell). In some aspects, the assisted UE may receive the SI or the SSB from the network node. In some other aspects, the assisted UE may receive at least a portion of the SI or the SSB from an assisting UE. The assisted UE may transmit, and the assisting UE may receive, a first message indicating that the assisted UE is to establish a connection with the network node. The assisting UE may transmit, and the network node may receive, a second message associated with a RACH process for establishing the connection between the assisted UE and the network node. For example, based at least in part on receiving the first message from the assisted UE, the assisting UE may transmit, and the network node may receive, an indication that the assisted UE is to perform the RACH process for establishing the connection between the assisted UE and the network node. The network node may transmit, and the assisted UE may receive, information for completing the RACH process. The information may include a success indication indicating that at least a portion of the RACH process is successful. In some aspects, the network node may transmit the success indication directly to the assisted UE, and the assisted UE may transmit an acknowledgement message (ACK) to the network node. In some other aspects, the network node may transmit the success indication to the assisting UE and the assisting UE may forward the information to the assisted UE. In these aspects, the assisted UE may transmit an ACK to the assisting UE, and the assisting UE may forward the ACK to the network node.

Particular aspects of the subject matter described in this disclosure can be implemented to realize one or more of the following potential advantages. In some aspects, by enabling the assisting UE to communicate the information associated with the assisted UE performing the RACH process for establishing the connection between the assisted UE and the network node, the described techniques can be used to reduce access latency. For example, by enabling the assisting UE to communicate the information associated with the assisted UE performing the RACH process, the described techniques may enable the assisted UE to bypass at least a portion of the RACH process, thereby reducing a duration for the assisted UE to access the network. In some aspects, by enabling the assisting UE to communicate the information associated with the assisted UE performing the RACH process, the described techniques can be used to improve contention resolution. For example, the described techniques may enable the assisted UE to avoid using random access opportunities (ROs) and, therefore, may reduce a likelihood of network collisions. In some aspects, by enabling the assisting UE to communicate the information associated with the assisted UE performing the RACH process, the described techniques can be used to reduce network energy consumption. For example, the described techniques can be used to reduce a quantity of transmissions for completing the RACH process. Additionally, the described techniques can be used to decrease an overall quantity of message transmissions for completing the RACH process, thereby reducing network energy consumption. In some aspects, by enabling the assisting UE to communicate the information associated with the assisted UE performing the RACH process, the described techniques can be used to reduce a likelihood of collision between collocated UEs performing the RACH process at the same time. These example advantages, among others, are described in more detail below.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

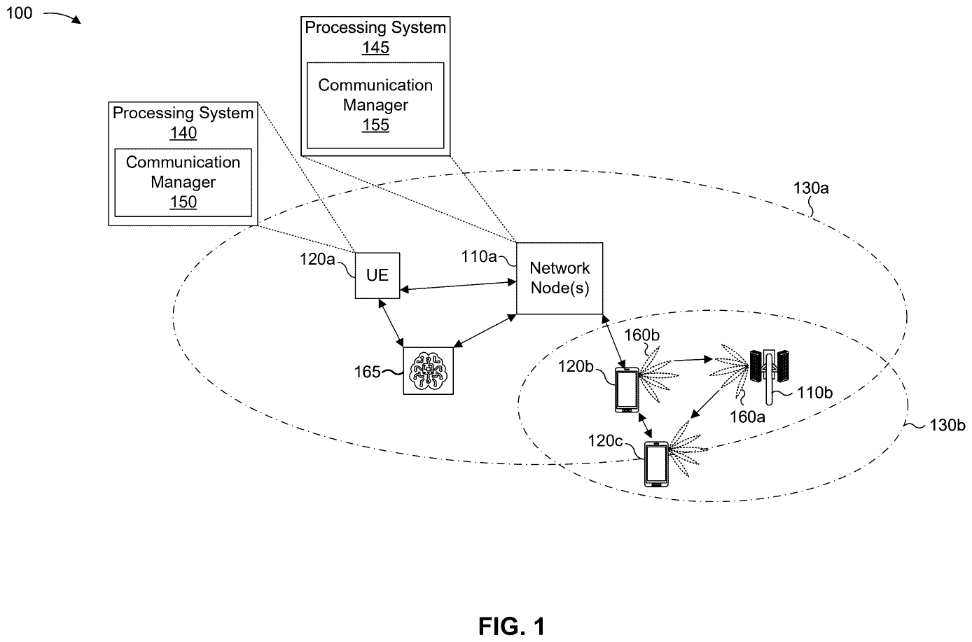

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an Ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The

AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. In some aspects, the communication manager 150 may receive, from an assisted UE, a first message indicating that the assisted UE is to establish a connection between the assisted UE and a network node; and transmit, to the network node, a second message associated with a random access channel process for establishing a connection between the assisted UE and the network node. In some other aspects, the communication manager 150 may transmit, to an assisting UE, a message indicating that the assisted UE is to establishing a connection between the assisted UE and a network node; and receive, from at least one of the assisting UE or the network node, information associated with a random access channel process for establishing the connection between the assisted UE and the network node. Additionally, or alternatively, the communication manager 150 may perform one or more other operations described herein.

In some aspects, the network node 110 may include a communication manager 155. As described in more detail elsewhere herein, the communication manager 155 may receive, from an assisting UE, a message indicating that an assisted UE is to establishing a connection between the assisted UE and the network node; and transmit, to at least one of the assisting UE or the assisted UE, information associated with a random access channel process for establishing a connection between the assisted UE and the network node. Additionally, or alternatively, the communication manager 155 may perform one or more other operations described herein.

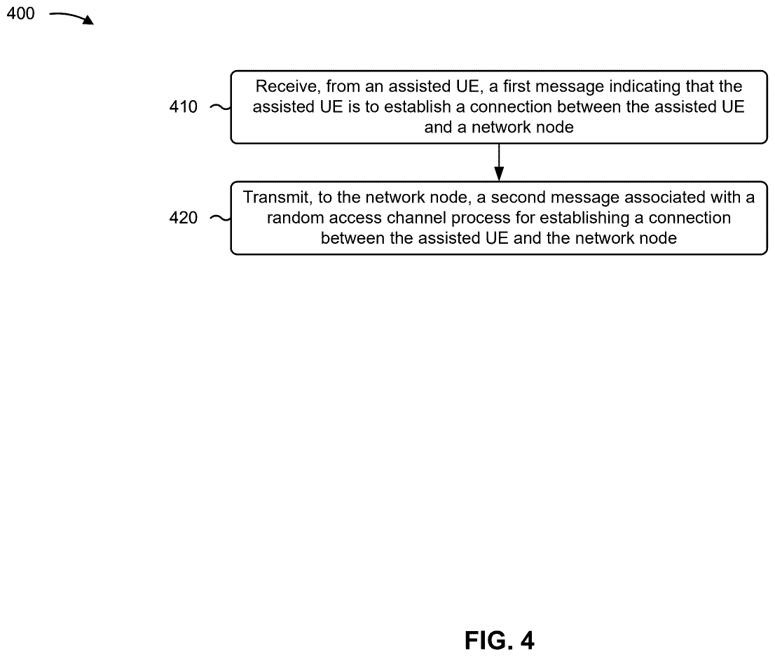

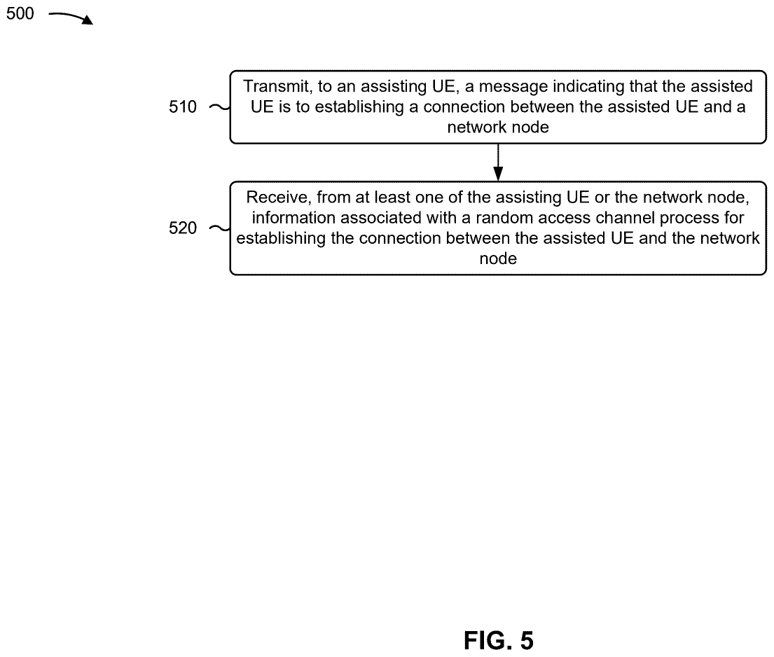

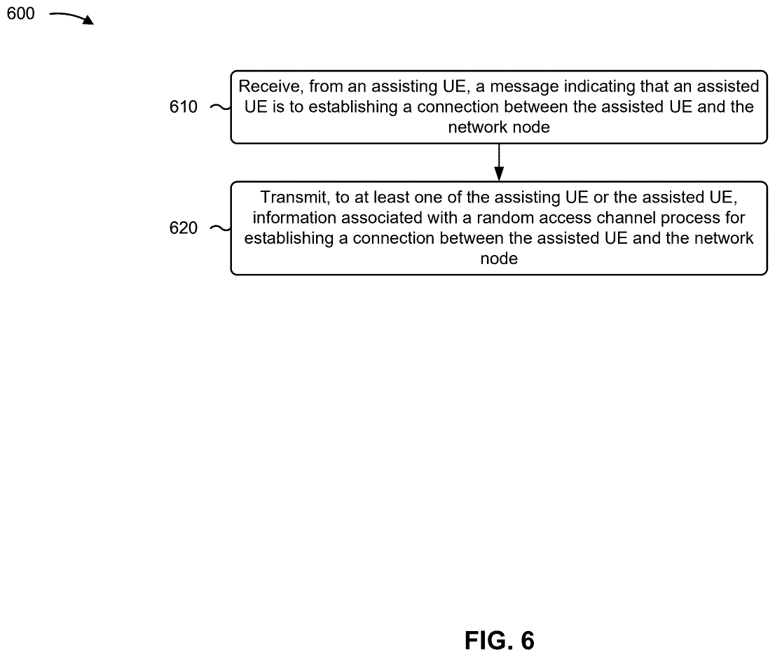

The network node 110, the processing system 145 of the network node 110, the UE 120, the processing system 140 of the UE 120, or any other component(s) of FIG. 1 may implement one or more techniques or perform one or more operations associated with UE assisted random access, as described in more detail elsewhere herein. For example, the processing system 145 of the network node 110, or the processing system 140 of the UE 120 may perform or direct operations of, for example, process 400 of FIG. 4, process 500 of FIG. 5, process 600 of FIG. 6, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, process 600 of FIG. 6, or other processes as described herein. In some examples, executing instructions may include running the instructions, converting the instructions, compiling the instructions, or interpreting the instructions, among other examples.

In some aspects, the UE 120 includes means for receiving, from an assisted UE, a first message indicating that the assisted UE is to establish a connection between the assisted UE and a network node; or means for transmitting, to the network node, a second message associated with a random access channel process for establishing a connection between the assisted UE and the network node. The means for the UE 120 to perform operations described herein may include, for example, one or more of communication manager 150, processing system 140, a radio, one or more RF chains, one or more transceivers, one or more antennas, one or more modems, a reception component, or a transmission component, among other examples.

In some aspects, the UE 120 includes means for transmitting, to an assisting UE, a message indicating that the UE 120 is to establishing a connection between the UE 120 and a network node; or means for receiving, from at least one of the assisting UE or the network node, information associated with a random access channel process for establishing the connection between the UE 120 and the network node. The means for the UE 120 to perform operations described herein may include, for example, one or more of communication manager 150, processing system 140, a radio, one or more RF chains, one or more transceivers, one or more antennas, one or more modems, a reception component, or a transmission component, among other examples.

In some aspects, the network node 110 includes means for receiving, from an assisting UE, a message indicating that an assisted UE is to establishing a connection between the assisted UE and the network node; or means for transmitting, to at least one of the assisting UE or the assisted UE, information associated with a random access channel process for establishing a connection between the assisted UE and the network node. The means for the network node 110 to perform operations described herein may include, for example, one or more of communication manager 155, processing system 145, a radio, one or more RF chains, one or more transceivers, one or more antennas, one or more modems, a reception component, or a transmission component, among other examples.

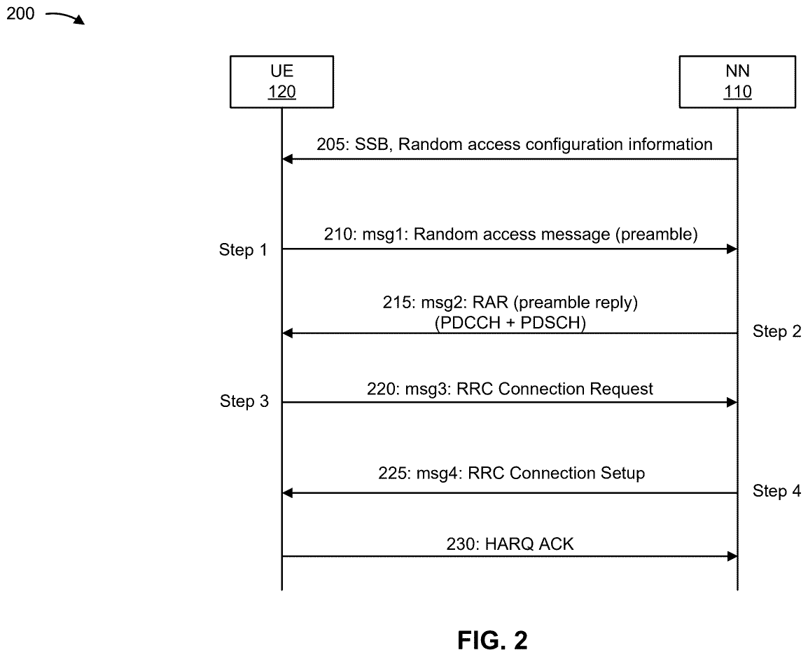

FIG. 2 is a diagram illustrating an example 200 of a four-step random access procedure. As shown in FIG. 2, a network node 110 and a UE 120 may communicate with one another to perform the four-step random access procedure.

As shown by reference number 205, the network node 110 may transmit, and the UE 120 may receive, one or more SSBs and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 210, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 215, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 220, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 225, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information.

As shown by reference number 230, if the UE 120 successfully receives the RRC connection setup message, the UE 120 may transmit a HARQ ACK.

As indicated above, FIG. 2 is provided as an example. Other examples may differ from what is described with regard to FIG. 2.

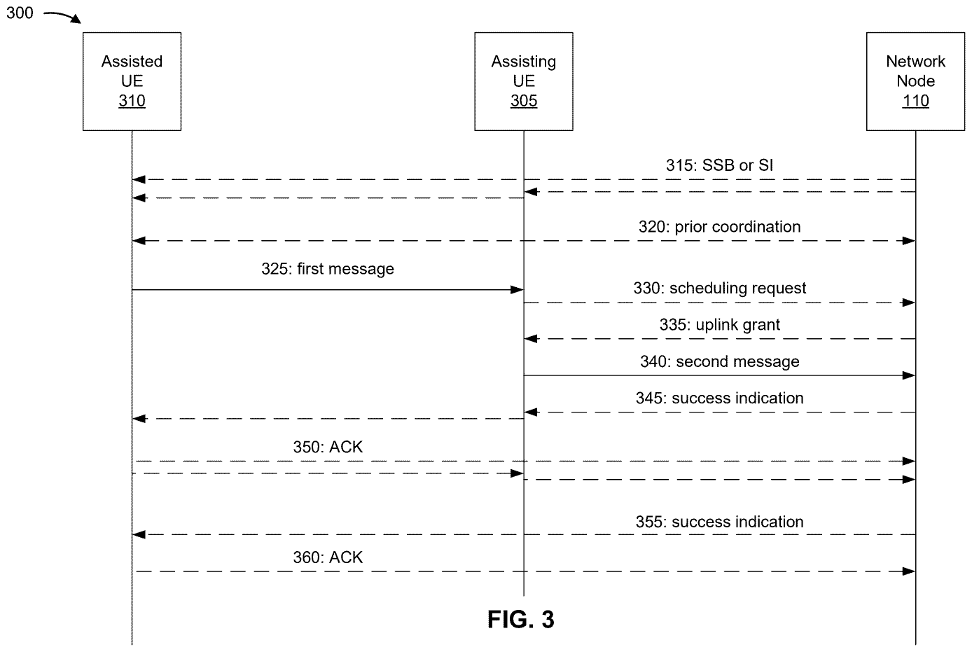

FIG. 3 is a diagram illustrating an example 300 of UE assisted random access. An assisting UE 305 may communicate with an assisted UE 310 and the network node 110. The assisting UE 305 and the assisted UE 310 may include some or all of the features of the UE 120 described herein. The network node 110 may be a target cell. In some aspects, the assisted UE 310 may be a single UE attempting to establish a connection to the network node 110. In some other aspects, the assisted UE 310 may be a plurality of assisted UEs 310 attempting to establish a connection with the network node 110. In some aspects, the connection between the assisting UE 305 and the assisted UE 310 may use any RAT. For example, the assisting UE 305 may or may not be a sidelink relay. In the example that the assisting UE is not a sidelink relay, the assisting UE 305 may not need to establish a remote-relay relationship with the assisted UE 310. In some aspects, the assisting UE 305 and the assisted UE 310 may be associated with a same user and may already be synched with each other. For example, the assisting UE 305 may be a cell phone, and the assisted UE 310 may be a smart watch that is synched with the cell phone. In some other aspects, the assisting UE 305 and the assisted UE 310 may be associated with different users. In these aspects, the assisting UE 305 and the assisted UE 310 may need to establish an initial connection with each other.

As shown by reference number 315, the network node may transmit, and the assisted UE 310 may receive, system information or synchronization information. In some aspects, the synchronization information may be, or may include, an SSB. In some aspects, the assisted UE 310 may receive the system information or the SSB directly from the network node 110. In some other aspects, the assisted UE 310 may receive at least a portion of the system information or the SSB from the assisting UE 305.

As shown by reference number 320, the assisted UE 310 and the network node 110 may have a prior connection. In some other aspects, the assisted UE 310 and the network node 110 may not have a prior connection.

As shown by reference number 325, the assisted UE 310 may transmit, and the assisting UE 305 may receive, a first message. The first message may indicate that the assisted UE is to establish a connection with the network node 110. In some aspects, the first message may be similar to a MSG3 of a legacy RACH process. In some aspects, the first message may reduce or eliminate a need for MSG1 and MSG3 transmissions, thereby simplifying the RACH process for the assisted UE 310, as described herein.

In some examples, the assisted UE 310 may be experiencing poor signal conditions or weak coverage from the network node 110, thereby impeding or reducing an ability of the assisted UE 310 communicate directly with the network 110. By leveraging the assisting UE 305, which may have a stronger connection to the network node 110, the assisted UE 310 may improve the likelihood of successful communication and connection establishment. In some examples, the assisted UE 310 may be operating under power constraints, such as limited battery life or energy-saving modes, and may seek to offload energy-intensive tasks associated with establishing a network connection to the assisting UE 305. The assisting UE 305, which may have more available power resources, may be configured to handle the communication process on behalf of the assisted UE 310, thereby reducing power consumption at the assisted UE 310. In some examples, the assisted UE 310 may be located in a high-latency environment where direct communication with the network node 110 could result in delays or increased contention. By utilizing the assisting UE 305, the assisted UE 310 may be able to reduce access latency and improve the efficiency of the random access channel process. In some examples, there may be scenarios where multiple UEs are collocated or moving together, and collaboration between UEs can optimize network operations. In such cases, the assisted UE 310 can benefit from the ability of assisting UE 305 to relay communications, share channel state information, or handle authentication processes, thereby enhancing the overall performance and reliability of the connection establishment process.

In some aspects, the first message may include an identifier of the assisted UE 310 (e.g., a temporary mobile subscriber identity (TMSI) of the assisted UE 310 or a radio network temporary identifier (RNTI) of the assisted UE 310), an identifier of the network node 110 (e.g., a target cell identifier), a cause of access indication (e.g., an RRC setup request), a coarse CSI indication of the network node 110 (e.g., an RSRP or estimated pathloss of the target cell), or beam information or SSB information associated with the assisted UE 310 (e.g., a selected beam of a strongest beam). Additionally, or alternatively, the first message may include timing information, such as information associated with the timing of the assisted UE 310 that can be used for calculation of a timing advance value towards the network node 110. The timing information may be associated with a local timing (e.g., an estimated propagation delay between the assisting UE 305 and the assisted UE 310), with reception timing from the network node 110, or the relative timing or timing difference between the receiving UE and a local time.

In some aspects, based at least in part on receiving the first message from the assisted UE 310, the assisting UE 305 may forward the information acquired from the assisted UE 310 to the network node 110. Additionally, or alternatively, the assisting UE 305 may provide feedback to the assisted UE 310. In some aspects, such as when multiple target cells are indicated, the feedback may include an indication of the network node 110 (or other target cells) to which the assisting UE 305 has forwarded the information received from the assisted UE 310. Additionally, or alternatively, the feedback may include an ACK or a NACK indicating whether the assisting UE 305 can assist the UE 310 with establishing the connection to the network node 110.

As shown by reference number 330, the assisting UE 305 may transmit, and the network node 110 may receive, a scheduling request. In some aspects, the assisting UE 305 may be configured with available uplink resources (e.g., dynamically granted uplink resources or configured grant PUSCH resources) that enable the assisting UE 305 to provide the information received from the assisted UE 310 to the network node 110. In some other aspects, the assisting UE 305 may need to send the scheduling request to request uplink resources from the network node 110. In these aspects, the scheduling request may include information that indicates a cause or an intention of the requested resources (e.g., establishing the connection between the assisted UE 310 and the network node 110). In some aspects, the assisting UE 305 may proactively send the scheduling request to the network node 110, such as before receiving the first message from the assisted UE 310. In these aspects, the assisting UE 305 may transmit the scheduling request based at least in part on the assisted UE 310 requesting the synchronization information or the SSB associated with the network node 110. Additionally, or alternatively, the assisted UE 310 may predict upcoming traffic or may predict a need to establish a connection, and may send an indication to the assisting UE 305 to request the uplink resources from the network node 110. In some aspects, the assisting UE 305 may receive a request from multiple assisted UEs 310 and may multiplex the requests into a single message to be transmitted to the network node 110.

As shown by reference number 335, the network node 110 may transmit, and the assisting UE 305 may receive, an uplink grant. The network node 110 may transmit the uplink grant to the assisting UE 305 based at least in part on receiving the scheduling request from the assisting UE 305.

As shown by reference number 340, the assisting UE 305 may transmit, and the network node 110 may receive, a second message. The second message may be associated with the assisted UE 310 performing a RACH process for establishing the connection between the assisted UE 310 and the network node 110. In some aspects, the second message may be the same as the first message. For example, the assisting UE 305 may receive the first message from the assisted UE 310 and may forward the first message to the network node 110 as the second message (or as part of the second message).

As shown by reference number 345, the network node 110 may transmit, and the assisted UE 310 may receive, a success indication. In a first example, the network node 110 may send the success indication to the assisting UE 305 to be forwarded by the assisting UE 305 to the assisted UE 310. In a second example, the network node 110 may send an ACK to the assisting UE 305 indicating that the network node 110 has received the second message and that the network node 110 is to send the success indication to the assisting UE 305 or the assisted UE 310 in a subsequent transmission. In a third example, the network node 110 may send the success indication directly to the assisted UE 310. In some aspects, the success indication may include a contention resolution identity associated with the assisted UE 310, transmit power control information associated with the assisted UE 310, timing advance information associated with the assisted UE 310, a radio network temporary identifier assigned by the network node 110, an RRC setup message, an RRC resume message, an expected behavior of the assisting UE 305 (e.g., information associated with forwarding the message to the assisted UE 310 or information associated with sending feedback to the network node 110), or an expected behavior of the assisted UE 310 (e.g., an indication of one or more resources to be monitored to receive subsequent messages from the network node 110).

In some aspects (e.g., in the first example described above), the assisting UE 305 may transmit an ACK to the network node 110 based at least in part on receiving the success indication from the network node 110. In some examples, the ACK may be sent to the network node 110 after the assisting UE 305 successfully decodes a PDSCH communication from the network node 110. In some examples, as shown by reference number 350, the ACK may be sent to the network node 110 after the assisting UE 305 receives another ACK from the assisted UE 310 indicating that the assisted UE 310 has received the message forwarded by the assisting UE 305. In this example, the network node 110 may not be able to provide uplink resources in advance of the assisted UE 310 transmitting the first message. Therefore, the assisting UE 305 may transmit a scheduling request to the network node 110 to obtain resources for transmitting the ACK, or may include the ACK within the scheduling request. In some aspects (e.g., in the second example described above), the ACK may be forwarded by the assisting UE 305 to the assisted UE 310. In some aspects, based at least in part on the assisting UE 305 not receiving the ACK from the network node 110 (e.g., after a configured maximum quantity of retransmissions or within a duration of a timer), the assisting UE 305 may transmit a NACK to the assisted UE 310 indicating that the assistance procedure is not successful. In these aspects, the assisted UE 310 may perform a cell reselection, may perform a RACH process directly with the network node 110, or may connect with another assisting UE.

As shown by reference number 355, and as described in the third example above, the network node 110 may transmit the success indication directly to the assisted UE 310. In some aspects, based at least in part on sending the first message to the assisting UE 305 or based at least in part on receiving the ACK from the assisting UE 305, the assisted UE 310 may initiate a timer and may monitor for a PDCCH communication from the network node 110. In some aspects, an RNTI used by the assisted UE 310 to monitor for the PDCCH communication from the network node 110 may be based at least in part on a function of the payload included in the first message. In some other aspects, the RNTI used by the assisted UE 310 to monitor for the PDCCH communication from the network node 110 may be based at least in part on the PUSCH resources used by the assisting UE 305 and communicated to the assisted UE 310 when the first message is communicated. In these aspects, the assisting UE 305 may report the RNTI to the assisted UE 310. In some aspects, the RNTI used by the assisted UE 310 to monitor for the PDCCH communication from the network node 110 may be based at least in part on a token or an identifier provided by the network node 110. In these aspects, at least one of the tokens or identifiers may be used as the RNTI by the assisted UE 310 in a coordination phase, and the assisting UE 305 can communicate the RNTI to the network node 110 when sending the second message.

As shown by reference number 360, the assisted UE 310 may transmit, and the network node may receive, an ACK. The assisted UE 310 may transmit the ACK to the network node 110 based at least in part on receiving the success indication from the network node 110. In some aspects, based at least in part on the assisted UE 310 not receiving a response from the network node 110 prior to an expiration of the timer, the assisted UE 310 may initiate the re-initiate the process (e.g., for a configured quantity of times). Additionally, or alternatively, the assisted UE 310 may perform a cell reselection, may perform a RACH directly with the network node 110, or may identify another assisted UE 310. In some aspects, the assisting UE 305 may cooperate with the assisted UE 310 in receiving or monitoring for the success indication from the network node 110 or with sending the ACK to the network node 110 (e.g., in a manner that is transparent to the network node 110).

In some aspects, the assisted UE 310 may perform uplink (transmission) power control based at least in part on receiving an SSB from the network node 110. In some aspects, the assisted UE 310 may perform an open-loop power control (e.g., where transmission power is defined in accordance with a transmission power associated with the PRACH) using a configured or indicated target receive power (e.g., which may be different from the target received power associated with the RACH in the MSG1) or using a configured or indicated decibel (dB) offset defined with respect to the indicated target received power for the RACH MSG1. In some other aspects, the assisted UE 310 may receive a transmission power control command for ACK transmissions from the network node 110 based at least in part on the assisting UE 305 reporting an estimated RSRP or path loss (e.g., directly or indirectly) to the network node 110. In some aspects, the assisted UE 310 may use transmission power control information included in the success indication based at least in part on a quasi co-location of the assisting UE 305 and the assisted UE 310. The transmission power control information included in the success indication may be based at least in part on a link between the network node 110 and the assisting UE 305 (and, optionally, an adjustment performed by the network node 110). In one example, the transmission power can be indicated or configured in accordance with a maximum value.

In some aspects, the assisted UE 310 may calculate a timing advance for an initial transmission by the assisted UE 310 to the network node 110. The timing advance may be based at least in part on an indication from the network node 110, a timing advance associated with the assisting UE 305, an indicated adjustment that is in accordance with a local propagation delay, or a configured adjustment that is in accordance with the local propagation delay.

In some aspects, one or more assisting UEs 305 may assist the assisted UE 310 with sending RACH messages via a system frame number (SFN) transmission in an example that the assisted UE 310 presents uplink overage or link-budget issues. In one example, multiple assisting UEs 305 may coordinate to send a RACH MSG1 using a SFN for the assisted UE 310, thereby increasing a likelihood of reception at the network node 110. In another example, multiple assisting UEs 305 can use the SFN to send other message associated with the RACH process. In some aspects, an uplink SFN may require coordination among multiple UEs. For example, multiple assisting UEs 305 may coordinate on the uplink resources selected for a combined uplink transmission by the multiple assisting UEs 305. Additionally, the multiple assisting UEs may adjust a transmission timing and a transmission power. In some aspects, coherent reception at the network node 110 may be required to support the SFN described above.

As indicated above, FIG. 3 is provided as an example. Other examples may differ from what is described with regard to FIG. 3.

FIG. 4 is a diagram illustrating an example process 400 performed, for example, at a UE or an apparatus of a UE. Example process 400 is an example where the apparatus or the UE (e.g., UE 120) performs operations associated with user equipment assisted random access.

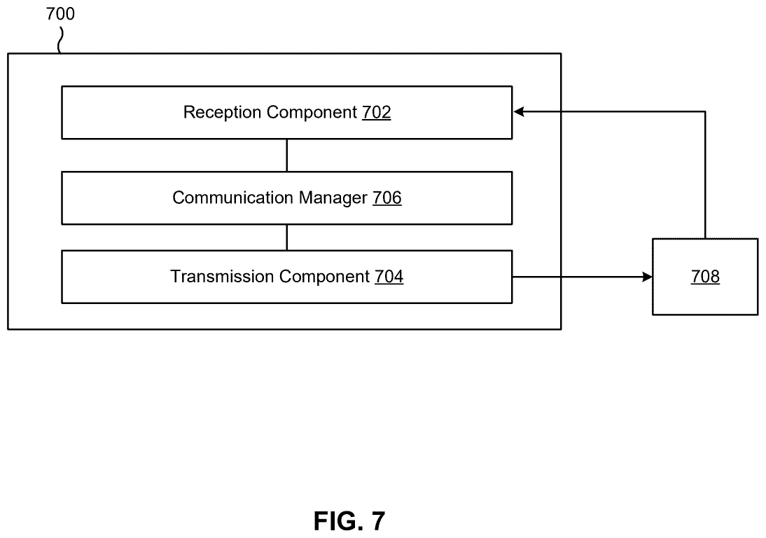

As shown in FIG. 4, in some aspects, process 400 may include receiving, from an assisted UE, a first message indicating that the assisted UE is to establish a connection between the assisted UE and a network node (block 410). For example, the UE (e.g., using reception component 702 or communication manager 706, depicted in FIG. 7) may receive, from an assisted UE, a first message indicating that the assisted UE is to establish a connection between the assisted UE and a network node, as described above.

As further shown in FIG. 4, in some aspects, process 400 may include transmitting, to the network node, a second message associated with a random access channel process for establishing a connection between the assisted UE and the network node (block 420). For example, the UE (e.g., using transmission component 704 or communication manager 706, depicted in FIG. 7) may transmit, to the network node, a second message associated with a random access channel process for establishing a connection between the assisted UE and the network node, as described above.

Process 400 may include additional aspects, such as any single aspect or any combination of aspects described below or in connection with one or more other processes described elsewhere herein.

In a first aspect, process 400 includes receiving, from the network node and prior to receiving the first message, at least one of system information or synchronization information associated with the assisted UE establishing the connection between the assisted UE and the network node, and transmitting, to the assisted UE, the system information or the synchronization information associated with the assisted UE establishing the connection between the assisted UE and the network node.

In a second aspect, alone or in combination with the first aspect, process 400 includes receiving, from the network node, information associated with the random access channel process for establishing the connection between the assisted UE and the network node, and transmitting, to the assisted UE, the information associated with the random access channel process.

In a third aspect, alone or in combination with one or more of the first and second aspects, the first message includes at least one of an identifier associated with the assisted UE, an identifier associated with the network node, a cause of access indication, a channel state information indication, beam information associated with the assisted UE, synchronization signal block information associated with the assisted UE, or timing information associated with the assisted UE.

In a fourth aspect, alone or in combination with one or more of the first through third aspects, transmitting the second message to the network node comprises forwarding the first message received from the assisted UE to the network node.

In a fifth aspect, alone or in combination with one or more of the first through fourth aspects, process 400 includes transmitting feedback to the assisted UE based at least in part on receiving the first message from the assisted UE, wherein the feedback includes at least one of an indication of one or more network nodes to which the assisting UE forwarded the first message, an acknowledgement message associated with forwarding the first message to the one or more network nodes, or a negative acknowledgement message associated with forwarding the first message to the one or more network nodes.

In a sixth aspect, alone or in combination with one or more of the first through fifth aspects, the assisting UE is configured with one or more uplink resources for transmitting the second message to the network node, wherein the one or more uplink resources include at least one of a dynamic grant uplink resource or a configured grant physical uplink shared channel resource.

In a seventh aspect, alone or in combination with one or more of the first through sixth aspects, process 400 includes transmitting, to the network node, a scheduling request message that requests one or more uplink resources for transmitting the second message to the network node, wherein the scheduling request message indicates an intention associated with obtaining the one or more uplink resources.

In an eighth aspect, alone or in combination with one or more of the first through seventh aspects, the scheduling request message is transmitted prior to the assisting UE receiving the first message from the assisted UE.

In a ninth aspect, alone or in combination with one or more of the first through eighth aspects, process 400 includes receiving, from the network node, at least one of a success indication to be forwarded by the assisting UE to the assisted UE or an acknowledgement message indicating that the network node is to provide the assisting UE or the assisted UE with the success indication.

In a tenth aspect, alone or in combination with one or more of the first through ninth aspects, the success indication includes at least one of a contention resolution identity associated with the assisted UE, a transmit power control parameter associated with the assisted UE, a timing advance parameter associated with the assisted UE, a cell radio network temporary identifier assigned by the network node, a radio resource control setup request indication, a radio resource control resume indication, a behavior parameter associated with the assisting UE, or a behavior parameter associated with the assisted UE.

In an eleventh aspect, alone or in combination with one or more of the first through tenth aspects, process 400 includes transmitting, based at least in part on receiving the success indication from the network node, an acknowledgement message to the network node, wherein the acknowledgement message is transmitted to the network node after the assisting UE decodes a physical downlink shared channel communication from the network node or after the assisting UE receives another acknowledgement message from the assisted UE.

In a twelfth aspect, alone or in combination with one or more of the first through eleventh aspects, process 400 includes forwarding, based at least in part on receiving the acknowledgement message from the network node, the acknowledgement message to the assisted UE.

In a thirteenth aspect, alone or in combination with one or more of the first through twelfth aspects, process 400 includes transmitting, based at least in part on failing to receive the acknowledgement message from the network node after a configured quantity of retransmissions of the second message or within a duration of a timer, a negative acknowledgement message to the assisted UE indicating that the random access channel process was not successful.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a UE or an apparatus of a UE. Example process 500 is an example where the apparatus or the UE (e.g., UE 120) performs operations associated with user equipment assisted random access.

As shown in FIG. 5, in some aspects, process 500 may include transmitting, to an assisting UE, a message indicating that the assisted UE is to establishing a connection between the assisted UE and a network node (block 510). For example, the UE (e.g., using transmission component 704 or communication manager 706, depicted in FIG. 7) may transmit, to an assisting UE, a message indicating that the assisted UE is to establishing a connection between the assisted UE and a network node, as described above. In some examples, the assisted UE may transmit the message to the assisting UE to leverage the stronger connection between the assisting UE and the network node (compared to the weaker connection between the assisted UE and the network node), to reduce energy consumption at the assisted UE, or to reduce access latency in challenging environments. By utilizing the conditions or communication properties of the assisting UE, the assisted UE can improve the likelihood of successful communication and connection establishment. This collaboration may improve network operations by enhancing communication reliability and efficiency.

As further shown in FIG. 5, in some aspects, process 500 may include receiving, from at least one of the assisting UE or the network node, information associated with a random access channel process for establishing the connection between the assisted UE and the network node (block 520). For example, the UE (e.g., using reception component 702 or communication manager 706, depicted in FIG. 7) may receive, from at least one of the assisting UE or the network node, information associated with a random access channel process for establishing the connection between the assisted UE and the network node, as described above.

Process 500 may include additional aspects, such as any single aspect or any combination of aspects described below or in connection with one or more other processes described elsewhere herein.

In a first aspect, process 500 includes receiving, from at least one of the assisting UE or the network node and prior to transmitting the message, at least one of system information or synchronization information associated with the assisted UE establishing the connection between the assisted UE and the network node.

In a second aspect, alone or in combination with the first aspect, the message includes at least one of an identifier associated with the assisted UE, an identifier associated with the network node, a cause of access indication, a channel state information indication, beam information associated with the assisted UE, synchronization signal block information associated with the assisted UE, or timing information associated with the assisted UE.

In a third aspect, alone or in combination with one or more of the first and second aspects, process 500 includes receiving feedback from the assisting UE based at least in part on transmitting the message to the assisting UE, wherein the feedback includes at least one of an indication of one or more network nodes to which the assisting UE forwarded the message, an acknowledgement message associated with forwarding the message to the one or more network nodes, or a negative acknowledgement message associated with forwarding the message to the one or more network nodes.

In a fourth aspect, alone or in combination with one or more of the first through third aspects, process 500 includes predicting upcoming traffic to be received by the assisted UE, and transmitting, to the assisting UE, an indication of the upcoming traffic.

In a fifth aspect, alone or in combination with one or more of the first through fourth aspects, receiving the information associated with the random access channel process for establishing the connection between the assisted UE and the network node comprises receiving at least one of a contention resolution identity associated with the assisted UE, a transmit power control parameter associated with the assisted UE, a timing advance parameter associated with the assisted UE, a cell radio network temporary identifier assigned by the network node, a radio resource control setup request indication, a radio resource control resume indication, a behavior parameter associated with the assisting UE, or a behavior parameter associated with the assisted UE.

In a sixth aspect, alone or in combination with one or more of the first through fifth aspects, process 500 includes receiving an acknowledgement message from the assisting UE indicating that the network node has received the message and indicating that the network node is to provide at least one of the assisted UE or the assisting UE with the information associated with performing the random access channel process.

In a seventh aspect, alone or in combination with one or more of the first through sixth aspects, process 500 includes initiating a timer or a monitoring for a physical downlink control channel communication from the network node based at least in part on transmitting the message to the assisting UE or based at least in part on receiving an acknowledgement message from the assisting UE.

In an eighth aspect, alone or in combination with one or more of the first through seventh aspects, monitoring for the physical downlink control channel communication from the network node comprises monitoring for the physical downlink control channel communication using a radio network temporary identifier, wherein the radio network temporary identifier is based at least in part on a payload included in the message, an indication of one or more physical uplink shared channel resources associated with the assisting UE, a token assigned by the network node, or an identifier assigned by the network node.

In a ninth aspect, alone or in combination with one or more of the first through eighth aspects, process 500 includes transmitting an acknowledgement message to the network node based at least in part on receiving a success indication from the network node.

In a tenth aspect, alone or in combination with one or more of the first through ninth aspects, process 500 includes restarting the timer based at least in part on failing to receive a success indication from the network node within a duration of the timer.

In an eleventh aspect, alone or in combination with one or more of the first through tenth aspects, process 500 includes performing an open loop power control based at least in part on receiving a synchronization signal block from the network node, wherein the open loop power control is based at least in part on a configured target receive power for an uplink transmission, an indicated target receive power for an uplink transmission, a configured decibel offset with respect to the indicated target receive power, or an indicated decibel offset with respect to the indicated target received power.

In a twelfth aspect, alone or in combination with one or more of the first through eleventh aspects, process 500 includes performing an open loop power control based at least in part on receiving a synchronization signal block from the network node, wherein the open loop power control is based at least in part on a transmit power control parameter associated with an acknowledgement message.

In a thirteenth aspect, alone or in combination with one or more of the first through twelfth aspects, process 500 includes performing an open loop power control based at least in part on a link between the network node and the assisting UE and based at least in part on an adjustment indication received from the network node.

In a fourteenth aspect, alone or in combination with one or more of the first through thirteenth aspects, process 500 includes calculating a timing advance value based at least in part on an indication from the network node, another target advance value associated with the assisting UE, an indicated timing advance adjustment, or a configured timing advance adjustment.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with user equipment assisted random access.

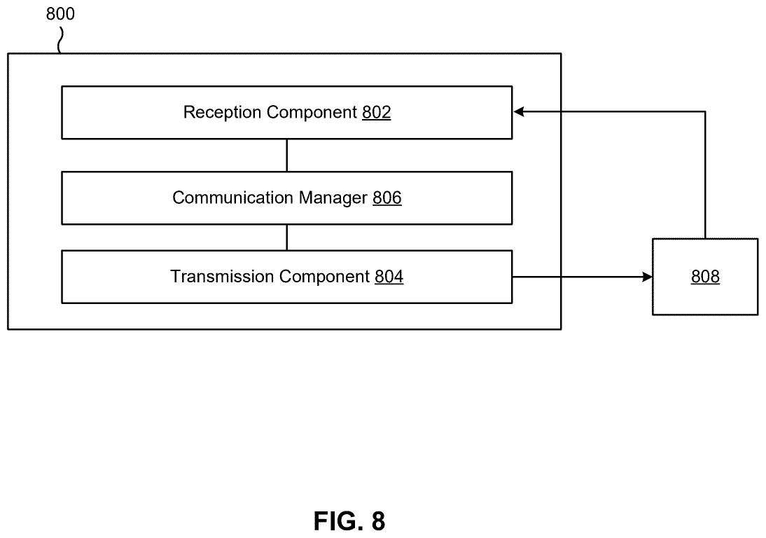

As shown in FIG. 6, in some aspects, process 600 may include receiving, from an assisting UE, a message indicating that an assisted UE is to establishing a connection between the assisted UE and the network node (block 610). For example, the network node (e.g., using reception component 802 or communication manager 806, depicted in FIG. 8) may receive, from an assisting UE, a message indicating that an assisted UE is to establishing a connection between the assisted UE and the network node, as described above.

As further shown in FIG. 6, in some aspects, process 600 may include transmitting, to at least one of the assisting UE or the assisted UE, information associated with a random access channel process for establishing a connection between the assisted UE and the network node (block 620). For example, the network node (e.g., using transmission component 804 or communication manager 806, depicted in FIG. 8) may transmit, to at least one of the assisting UE or the assisted UE, information associated with a random access channel process for establishing a connection between the assisted UE and the network node, as described above.

Process 600 may include additional aspects, such as any single aspect or any combination of aspects described below or in connection with one or more other processes described elsewhere herein.

In a first aspect, process 600 includes transmitting, to at least one of the assisting UE or the assisted UE, at least one of system information or synchronization information associated with the assisted UE establishing the connection between the assisted UE and the network node.

In a second aspect, alone or in combination with the first aspect, the message includes at least one of an identifier associated with the assisted UE, an identifier associated with the network node, a cause of access indication, a channel state information indication, beam information associated with the assisted UE, synchronization signal block information associated with the assisted UE, or timing information associated with the assisted UE.

In a third aspect, alone or in combination with one or more of the first and second aspects, process 600 includes transmitting, to the assisting UE, an uplink grant that indicates one or more uplink resources for transmitting the message to the network node.

In a fourth aspect, alone or in combination with one or more of the first through third aspects, transmitting the information associated with the random access channel process for establishing the connection between the assisted UE and the network node comprises transmitting a success indication to the assisting UE to be forwarded by the assisting UE to the assisted UE, transmitting an acknowledgement message indicating that the network node is to provide the assisting UE or the assisted UE with the success indication, or transmitting the success indication to the assisted UE.

In a fifth aspect, alone or in combination with one or more of the first through fourth aspects, the information includes at least one of a contention resolution identity associated with the assisted UE, a transmit power control parameter associated with the assisted UE, a timing advance parameter associated with the assisted UE, a cell radio network temporary identifier assigned by the network node, a radio resource control setup request indication, a radio resource control resume indication, a behavior parameter associated with the assisting UE, or a behavior parameter associated with the assisted UE.

In a sixth aspect, alone or in combination with one or more of the first through fifth aspects, process 600 includes receiving an acknowledgement message from the assisting UE based at least in part on transmitting the information to the assisting UE.

In a seventh aspect, alone or in combination with one or more of the first through sixth aspects, process 600 includes receiving an acknowledgement message from the assisted UE based at least in part on transmitting the information to the assisted UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIG. 3. 3 Additionally, or alternatively, the apparatus 700 may be configured to perform one or more processes described herein, such as process 400 of FIG. 4, process 500 of FIG. 5, or a combination thereof. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, from an assisted UE, a first message indicating that the assisted UE is to establish a connection between the assisted UE and a network node. The transmission component 704 may transmit, to the network node, a second message associated with a random access channel process for establishing a connection between the assisted UE and the network node.

The reception component 702 may receive, from the network node and prior to receiving the first message, at least one of system information or synchronization information associated with the assisted UE establishing the connection between the assisted UE and the network node. The transmission component 704 may transmit, to the assisted UE, the system information or the synchronization information associated with the assisted UE establishing the connection between the assisted UE and the network node. The reception component 702 may receive, from the network node, information associated with the random access channel process for establishing the connection between the assisted UE and the network node. The transmission component 704 may transmit, to the assisted UE, the information associated with the random access channel process. The transmission component 704 may transmit feedback to the assisted UE based at least in part on receiving the first message from the assisted UE, wherein the feedback includes at least one of an indication of one or more network nodes to which the assisting UE forwarded the first message, an acknowledgement message associated with forwarding the first message to the one or more network nodes, or a negative acknowledgement message associated with forwarding the first message to the one or more network nodes.

The transmission component 704 may transmit, to the network node, a scheduling request message that requests one or more uplink resources for transmitting the second message to the network node, wherein the scheduling request message indicates an intention associated with obtaining the one or more uplink resources. The reception component 702 may receive, from the network node, at least one of a success indication to be forwarded by the assisting UE to the assisted UE or an acknowledgement message indicating that the network node is to provide the assisting UE or the assisted UE with the success indication. The transmission component 704 may transmit, based at least in part on receiving the success indication from the network node, an acknowledgement message to the network node, wherein the acknowledgement message is transmitted to the network node after the assisting UE decodes a physical downlink shared channel communication from the network node or after the assisting UE receives another acknowledgement message from the assisted UE. The communication manager 706 may forward, based at least in part on receiving the acknowledgement message from the network node, the acknowledgement message to the assisted UE. The transmission component 704 may transmit, based at least in part on failing to receive the acknowledgement message from the network node after a configured quantity of retransmissions of the second message or within a duration of a timer, a negative acknowledgement message to the assisted UE indicating that the random access channel process was not successful.

The transmission component 704 may transmit, to an assisting UE, a message indicating that the assisted UE is to establishing a connection between the assisted UE and a network node. The reception component 702 may receive, from at least one of the assisting UE or the network node, information associated with a random access channel process for establishing the connection between the assisted UE and the network node.

The reception component 702 may receive, from at least one of the assisting UE or the network node and prior to transmitting the message, at least one of system information or synchronization information associated with the assisted UE establishing the connection between the assisted UE and the network node. The reception component 702 may receive feedback from the assisting UE based at least in part on transmitting the message to the assisting UE, wherein the feedback includes at least one of an indication of one or more network nodes to which the assisting UE forwarded the message, an acknowledgement message associated with forwarding the message to the one or more network nodes, or a negative acknowledgement message associated with forwarding the message to the one or more network nodes. The communication manager 706 may predict upcoming traffic to be received by the assisted UE. The transmission component 704 may transmit, to the assisting UE, an indication of the upcoming traffic.

The reception component 702 may receive an acknowledgement message from the assisting UE indicating that the network node has received the message and indicating that the network node is to provide at least one of the assisted UE or the assisting UE with the information associated with performing the random access channel process. The communication manager 706 may initiate a timer or a monitoring for a physical downlink control channel communication from the network node based at least in part on transmitting the message to the assisting UE or based at least in part on receiving an acknowledgement message from the assisting UE. The transmission component 704 may transmit an acknowledgement message to the network node based at least in part on receiving a success indication from the network node. The communication manager 706 may restart the timer based at least in part on failing to receive a success indication from the network node within a duration of the timer.

The communication manager 706 may perform an open loop power control based at least in part on receiving a synchronization signal block from the network node, wherein the open loop power control is based at least in part on a configured target receive power for an uplink transmission, an indicated target receive power for an uplink transmission, a configured decibel offset with respect to the indicated target receive power, or an indicated decibel offset with respect to the indicated target received power. The communication manager 706 may perform an open loop power control based at least in part on receiving a synchronization signal block from the network node, wherein the open loop power control is based at least in part on a transmit power control parameter associated with an acknowledgement message. The communication manager 706 may perform an open loop power control based at least in part on a link between the network node and the assisting UE and based at least in part on an adjustment indication received from the network node. The communication manager 706 may calculate a timing advance value based at least in part on an indication from the network node, another target advance value associated with the assisting UE, an indicated timing advance adjustment, or a configured timing advance adjustment.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIG. 3. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, from an assisting UE, a message indicating that an assisted UE is to establishing a connection between the assisted UE and the network node. The transmission component 804 may transmit, to at least one of the assisting UE or the assisted UE, information associated with a random access channel process for establishing a connection between the assisted UE and the network node.

The transmission component 804 may transmit, to at least one of the assisting UE or the assisted UE, at least one of system information or synchronization information associated with the assisted UE establishing the connection between the assisted UE and the network node. The transmission component 804 may transmit, to the assisting UE, an uplink grant that indicates one or more uplink resources for transmitting the message to the network node. The reception component 802 may receive an acknowledgement message from the assisting UE based at least in part on transmitting the information to the assisting UE. The reception component 802 may receive an acknowledgement message from the assisted UE based at least in part on transmitting the information to the assisted UE.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by an assisting user equipment (UE), comprising: receiving, from an assisted UE, a first message indicating that the assisted UE is to establish a connection between the assisted UE and a network node; and transmitting, to the network node, a second message associated with a random access channel process for establishing a connection between the assisted UE and the network node.
Aspect 2: The method of Aspect 1, further comprising: receiving, from the network node and prior to receiving the first message, at least one of system information or synchronization information associated with the assisted UE establishing the connection between the assisted UE and the network node; and transmitting, to the assisted UE, the system information or the synchronization information associated with the assisted UE establishing the connection between the assisted UE and the network node.
Aspect 3: The method of any of Aspects 1-2, further comprising: receiving, from the network node, information associated with the random access channel process for establishing the connection between the assisted UE and the network node; and transmitting, to the assisted UE, the information associated with the random access channel process.
Aspect 4: The method of any of Aspects 1-3, wherein the first message includes at least one of an identifier associated with the assisted UE, an identifier associated with the network node, a cause of access indication, a channel state information indication, beam information associated with the assisted UE, synchronization signal block information associated with the assisted UE, or timing information associated with the assisted UE.
Aspect 5: The method of any of Aspects 1-4, wherein transmitting the second message to the network node comprises forwarding the first message received from the assisted UE to the network node.
Aspect 6: The method of any of Aspects 1-5, further comprising transmitting feedback to the assisted UE based at least in part on receiving the first message from the assisted UE, wherein the feedback includes at least one of an indication of one or more network nodes to which the assisting UE forwarded the first message, an acknowledgement message associated with forwarding the first message to the one or more network nodes, or a negative acknowledgement message associated with forwarding the first message to the one or more network nodes.
Aspect 7: The method of any of Aspects 1-6, wherein the assisting UE is configured with one or more uplink resources for transmitting the second message to the network node, wherein the one or more uplink resources include at least one of a dynamic grant uplink resource or a configured grant physical uplink shared channel resource.
Aspect 8: The method of any of Aspects 1-7, further comprising transmitting, to the network node, a scheduling request message that requests one or more uplink resources for transmitting the second message to the network node, wherein the scheduling request message indicates an intention associated with obtaining the one or more uplink resources.
Aspect 9: The method of Aspect 8, wherein the scheduling request message is transmitted prior to the assisting UE receiving the first message from the assisted UE.
Aspect 10: The method of any of Aspects 1-9, further comprising receiving, from the network node, at least one of a success indication to be forwarded by the assisting UE to the assisted UE or an acknowledgement message indicating that the network node is to provide the assisting UE or the assisted UE with the success indication.
Aspect 11: The method of Aspect 10, wherein the success indication includes at least one of a contention resolution identity associated with the assisted UE, a transmit power control parameter associated with the assisted UE, a timing advance parameter associated with the assisted UE, a cell radio network temporary identifier assigned by the network node, a radio resource control setup request indication, a radio resource control resume indication, a behavior parameter associated with the assisting UE, or a behavior parameter associated with the assisted UE.
Aspect 12: The method of Aspect 10, further comprising transmitting, based at least in part on receiving the success indication from the network node, an acknowledgement message to the network node, wherein the acknowledgement message is transmitted to the network node after the assisting UE decodes a physical downlink shared channel communication from the network node or after the assisting UE receives another acknowledgement message from the assisted UE.
Aspect 13: The method of Aspect 10, further comprising forwarding, based at least in part on receiving the acknowledgement message from the network node, the acknowledgement message to the assisted UE.
Aspect 14: The method of Aspect 10, further comprising transmitting, based at least in part on failing to receive the acknowledgement message from the network node after a configured quantity of retransmissions of the second message or within a duration of a timer, a negative acknowledgement message to the assisted UE indicating that the random access channel process was not successful.
Aspect 15: A method of wireless communication performed by an assisted user equipment (UE), comprising: transmitting, to an assisting UE, a message indicating that the assisted UE is to establishing a connection between the assisted UE and a network node; and receiving, from at least one of the assisting UE or the network node, information associated with a random access channel process for establishing the connection between the assisted UE and the network node.
Aspect 16: The method of Aspect 15, further comprising receiving, from at least one of the assisting UE or the network node and prior to transmitting the message, at least one of system information or synchronization information associated with the assisted UE establishing the connection between the assisted UE and the network node.
Aspect 17: The method of any of Aspects 15-16, wherein the message includes at least one of an identifier associated with the assisted UE, an identifier associated with the network node, a cause of access indication, a channel state information indication, beam information associated with the assisted UE, synchronization signal block information associated with the assisted UE, or timing information associated with the assisted UE.
Aspect 18: The method of any of Aspects 15-17, further comprising receiving feedback from the assisting UE based at least in part on transmitting the message to the assisting UE, wherein the feedback includes at least one of an indication of one or more network nodes to which the assisting UE forwarded the message, an acknowledgement message associated with forwarding the message to the one or more network nodes, or a negative acknowledgement message associated with forwarding the message to the one or more network nodes.
Aspect 19: The method of any of Aspects 15-18, further comprising: predicting upcoming traffic to be received by the assisted UE; and transmitting, to the assisting UE, an indication of the upcoming traffic.

Aspect 20: The method of any of Aspects 15-19, wherein receiving the information associated with the random access channel process for establishing the connection between the assisted UE and the network node comprises receiving at least one of a contention resolution identity associated with the assisted UE, a transmit power control parameter associated with the assisted UE, a timing advance parameter associated with the assisted UE, a cell radio network temporary identifier assigned by the network node, a radio resource control setup request indication, a radio resource control resume indication, a behavior parameter associated with the assisting UE, or a behavior parameter associated with the assisted UE.

Aspect 21: The method of Aspect 20, further comprising receiving an acknowledgement message from the assisting UE indicating that the network node has received the message and indicating that the network node is to provide at least one of the assisted UE or the assisting UE with the information associated with performing the random access channel process.

Aspect 22: The method of any of Aspects 15-21, further comprising initiating a timer or a monitoring for a physical downlink control channel communication from the network node based at least in part on transmitting the message to the assisting UE or based at least in part on receiving an acknowledgement message from the assisting UE.

Aspect 23: The method of Aspect 22, wherein monitoring for the physical downlink control channel communication from the network node comprises monitoring for the physical downlink control channel communication using a radio network temporary identifier, wherein the radio network temporary identifier is based at least in part on a payload included in the message, an indication of one or more physical uplink shared channel resources associated with the assisting UE, a token assigned by the network node, or an identifier assigned by the network node.

Aspect 24: The method of Aspect 22, further comprising transmitting an acknowledgement message to the network node based at least in part on receiving a success indication from the network node.

Aspect 25: The method of Aspect 22, further comprising restarting the timer based at least in part on failing to receive a success indication from the network node within a duration of the timer.

Aspect 26: The method of any of Aspects 15-25, further comprising performing an open loop power control based at least in part on receiving a synchronization signal block from the network node, wherein the open loop power control is based at least in part on a configured target receive power for an uplink transmission, an indicated target receive power for an uplink transmission, a configured decibel offset with respect to the indicated target receive power, or an indicated decibel offset with respect to the indicated target received power.

Aspect 27: The method of any of Aspects 15-26, further comprising performing an open loop power control based at least in part on receiving a synchronization signal block from the network node, wherein the open loop power control is based at least in part on a transmit power control parameter associated with an acknowledgement message.

Aspect 28: The method of any of Aspects 15-27, further comprising performing an open loop power control based at least in part on a link between the network node and the assisting UE and based at least in part on an adjustment indication received from the network node.

Aspect 29: The method of any of Aspects 15-28, further comprising calculating a timing advance value based at least in part on an indication from the network node, another target advance value associated with the assisting UE, an indicated timing advance adjustment, or a configured timing advance adjustment.

Aspect 30: A method of wireless communication performed by a network node, comprising: receiving, from an assisting UE, a message indicating that an assisted UE is to establishing a connection between the assisted UE and the network node; and transmitting, to at least one of the assisting UE or the assisted UE, information associated with a random access channel process for establishing a connection between the assisted UE and the network node.

Aspect 31: The method of Aspect 30, further comprising transmitting, to at least one of the assisting UE or the assisted UE, at least one of system information or synchronization information associated with the assisted UE establishing the connection between the assisted UE and the network node.

Aspect 32: The method of any of Aspects 30-31, wherein the message includes at least one of an identifier associated with the assisted UE, an identifier associated with the network node, a cause of access indication, a channel state information indication, beam information associated with the assisted UE, synchronization signal block information associated with the assisted UE, or timing information associated with the assisted UE.

Aspect 33: The method of any of Aspects 30-32, further comprising transmitting, to the assisting UE, an uplink grant that indicates one or more uplink resources for transmitting the message to the network node.

Aspect 34: The method of any of Aspects 30-33, wherein transmitting the information associated with the random access channel process for establishing the connection between the assisted UE and the network node comprises transmitting a success indication to the assisting UE to be forwarded by the assisting UE to the assisted UE, transmitting an acknowledgement message indicating that the network node is to provide the assisting UE or the assisted UE with the success indication, or transmitting the success indication to the assisted UE.

Aspect 35: The method of any of Aspects 30-34, wherein the information includes at least one of a contention resolution identity associated with the assisted UE, a transmit power control parameter associated with the assisted UE, a timing advance parameter associated with the assisted UE, a cell radio network temporary identifier assigned by the network node, a radio resource control setup request indication, a radio resource control resume indication, a behavior parameter associated with the assisting UE, or a behavior parameter associated with the assisted UE.

Aspect 36: The method of any of Aspects 30-35, further comprising receiving an acknowledgement message from the assisting UE based at least in part on transmitting the information to the assisting UE.

Aspect 37: The method of any of Aspects 30-36, further comprising receiving an acknowledgement message from the assisted UE based at least in part on transmitting the information to the assisted UE.

Aspect 38: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-37.

Aspect 39: An apparatus for wireless communication at a device, the apparatus comprising one or more memories and one or more processors coupled to the one or more memories, the one or more processors configured to cause the device to perform the method of one or more of Aspects 1-37.

Aspect 40: An apparatus for wireless communication, the apparatus comprising at least one means for performing the method of one or more of Aspects 1-37.

Aspect 41: A non-transitory computer-readable medium storing code for wireless communication, the code comprising instructions executable by one or more processors to perform the method of one or more of Aspects 1-37.

Aspect 42: A non-transitory computer-readable medium storing a set of instructions for wireless communication, the set of instructions comprising one or more instructions that, when executed by one or more processors of a device, cause the device to perform the method of one or more of Aspects 1-37.

Aspect 43: A device for wireless communication, the device comprising a processing system that includes one or more processors and one or more memories coupled with the one or more processors, the processing system configured to cause the device to perform the method of one or more of Aspects 1-37.

Aspect 44: An apparatus for wireless communication at a device, the apparatus comprising one or more memories and one or more processors coupled to the one or more memories, the one or more processors individually or collectively configured to cause the device to perform the method of one or more of Aspects 1-37.

Aspect 45: A device comprising a processing system that includes one or more processors and one or more code-storing memories coupled with the one or more processors, the processing system configured to cause the device to perform the method of one or more of Aspects 1-37.

Aspect 46: A device comprising a processing system that includes processor circuitry and code-storing memory circuitry, the processing system configured to cause the device to perform the method of one or more of Aspects 1-37.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at an assisting user equipment (UE), comprising:
one or more memories; and
one or more processors, coupled to the one or more memories, configured to cause the UE to:
receive, from an assisted UE, a first message indicating that the assisted UE is to establish a connection between the assisted UE and a network node; and
transmit, to the network node, a second message associated with a random access channel process for establishing a connection between the assisted UE and the network node.

2. The apparatus of claim 1, wherein the one or more processors are further configured to cause the UE to:
receive, from the network node and prior to receiving the first message, at least one of system information or synchronization information associated with the assisted UE establishing the connection between the assisted UE and the network node; and
transmit, to the assisted UE, the system information or the synchronization information associated with the assisted UE establishing the connection between the assisted UE and the network node.

3. The apparatus of claim 1, wherein the one or more processors are further configured to cause the UE to:
receive, from the network node, information associated with the random access channel process for establishing the connection between the assisted UE and the network node; and
transmit, to the assisted UE, the information associated with the random access channel process.

4. The apparatus of claim 1, wherein the first message includes at least one of an identifier associated with the assisted UE, an identifier associated with the network node, a cause of access indication, a channel state information indication, beam information associated with the assisted UE, synchronization signal block information associated with the assisted UE, or timing information associated with the assisted UE.

5. The apparatus of claim 1, wherein the one or more processors, to cause the UE to transmit the second message to the network node, are configured to cause the UE to forward the first message received from the assisted UE to the network node.

6. The apparatus of claim 1, wherein the one or more processors are further configured to cause the UE to transmit feedback to the assisted UE based at least in part on receiving the first message from the assisted UE, wherein the feedback includes at least one of an indication of one or more network nodes to which the assisting UE forwarded the first message, an acknowledgement message associated with forwarding the first message to the one or more network nodes, or a negative acknowledgement message associated with forwarding the first message to the one or more network nodes.

7. The apparatus of claim 1, wherein the assisting UE is configured with one or more uplink resources for transmitting the second message to the network node, wherein the one or more uplink resources include at least one of a dynamic grant uplink resource or a configured grant physical uplink shared channel resource.

8. The apparatus of claim 1, wherein the one or more processors are further configured to cause the UE to transmit, to the network node, a scheduling request message that requests one or more uplink resources for transmitting the second message to the network node, wherein the scheduling request message indicates an intention associated with obtaining the one or more uplink resources.

9. The apparatus of claim 8, wherein the scheduling request message is transmitted prior to the assisting UE receiving the first message from the assisted UE.

10. The apparatus of claim 1, wherein the one or more processors are further configured to cause the UE to receive, from the network node, at least one of a success indication to be forwarded by the assisting UE to the assisted UE or an acknowledgement message indicating that the network node is to provide the assisting UE or the assisted UE with the success indication.

11. The apparatus of claim 10, wherein the success indication includes at least one of a contention resolution identity associated with the assisted UE, a transmit power control parameter associated with the assisted UE, a timing advance parameter associated with the assisted UE, a cell radio network temporary identifier assigned by the network node, a radio resource control setup request indication, a radio resource control resume indication, a behavior parameter associated with the assisting UE, or a behavior parameter associated with the assisted UE.

12. The apparatus of claim 10, wherein the one or more processors are further configured to cause the UE to transmit, based at least in part on receiving the success indication from the network node, an acknowledgement message to the network node, wherein the acknowledgement message is transmitted to the network node after the assisting UE decodes a physical downlink shared channel communication from the network node or after the assisting UE receives another acknowledgement message from the assisted UE.

13. The apparatus of claim 10, wherein the one or more processors are further configured to cause the UE to forward, based at least in part on receiving the acknowledgement message from the network node, the acknowledgement message to the assisted UE.

14. The apparatus of claim 10, wherein the one or more processors are further configured to cause the UE to transmit, based at least in part on failing to receive the acknowledgement message from the network node after a configured quantity of retransmissions of the second message or within a duration of a timer, a negative acknowledgement message to the assisted UE indicating that the random access channel process was not successful.

15. An apparatus for wireless communication at an assisted user equipment (UE), comprising:
one or more memories; and
one or more processors, coupled to the one or more memories, configured to cause the UE to:
transmit, to an assisting UE, a message indicating that the assisted UE is to establishing a connection between the assisted UE and a network node; and
receive, from at least one of the assisting UE or the network node, information associated with a random access channel process for establishing the connection between the assisted UE and the network node.

16. The apparatus of claim 15, wherein the message includes at least one of an identifier associated with the assisted UE, an identifier associated with the network node, a cause of access indication, a channel state information indication, beam information associated with the assisted UE, synchronization signal block information associated with the assisted UE, or timing information associated with the assisted UE.

17. The apparatus of claim 15, wherein the one or more processors are further configured to cause the UE to receive feedback from the assisting UE based at least in part on transmitting the message to the assisting UE, wherein the feedback includes at least one of an indication of one or more network nodes to which the assisting UE forwarded the message, an acknowledgement message associated with forwarding the message to the one or more network nodes, or a negative acknowledgement message associated with forwarding the message to the one or more network nodes.

18. The apparatus of claim 15, wherein the one or more processors are further configured to cause the UE to:
predict upcoming traffic to be received by the assisted UE; and
transmit, to the assisting UE, an indication of the upcoming traffic.

19. The apparatus of claim 15, wherein the one or more processors, to cause the UE to receive the information associated with the random access channel process for establishing the connection between the assisted UE and the network node, are configured to cause the UE to receive at least one of a contention resolution identity associated with the assisted UE, a transmit power control parameter associated with the assisted UE, a timing advance parameter associated with the assisted UE, a cell radio network temporary identifier assigned by the network node, a radio resource control setup request indication, a radio resource control resume indication, a behavior parameter associated with the assisting UE, or a behavior parameter associated with the assisted UE.

20. An apparatus for wireless communication at a network node, comprising:
one or more memories; and
one or more processors, coupled to the one or more memories, configured to cause the network node to:
receive, from an assisting UE, a message indicating that an assisted UE is to establishing a connection between the assisted UE and the network node; and
transmit, to at least one of the assisting UE or the assisted UE, information associated with a random access channel process for establishing a connection between the assisted UE and the network node.
